(19) United States
(12) Patent Application Publication
(10) Pub. No.: US 2023/0015620 A1
(43) Pub. Date: Jan. 19, 2023

(54) REPURPOSING WASTE ALUMINUM POWDER BY NET SHAPE SINTERING

(71) Applicant: Divergent Technologies, Inc., Los Angeles, CA (US)

(72) Inventors: Chan Cheong PUN, Costa Mesa, CA (US); Michael Thomas KENWORTHY, Los Angeles, CA (US)

(21) Appl. No.: 17/860,394

(22) Filed: Jul. 8, 2022

Related U.S. Application Data
(60) Provisional application No. 63/221,885, filed on Jul. 14, 2021.

(51) Int. Cl. B22F 3/15; B33Y 99/00; B22F 3/24; B22F 9/04

(52) U.S. Cl. CPC B22F 3/15; B33Y 99/00; B22F 3/24; B22F 9/04; B22F 2301/052; B22F 2003/247; B22F 2302/253; B22F 2009/043

(57) ABSTRACT

Methods for repurposing waste materials, such as aluminum powder, are disclosed. A method in accordance with an aspect of the present disclosure may comprise collecting a material in a container, the material comprising oxidized aluminum powder, processing the material, which includes heating the material to melt at least a portion of the oxidized aluminum powder, and forming the processed material into at least one component.

### CROSS-REFERENCE TO RELATED APPLICATIONS

The present disclosure claims the benefit under 35 U.S.C. 119 of U.S. Provisional Patent Application No. 63/221,885, filed Jul. 14, 2021 and entitled “REPURPOSING WASTE ALUMINUM POWDER BY NET SHAPE SINTERING”, which application is incorporated by reference herein in its entirety.

### BACKGROUND

### Field

The present disclosure relates generally to additive manufacturing, and more specifically to repurposing the waste created during additive manufacturing.

### Description of the Related Technology

Some Additive Manufacturing (AM) processes involve the use of a stored geometrical model for accumulating layered materials on a “build plate” to produce three-dimensional (3-D) objects having features defined by the model. AM techniques are capable of printing complex parts or components using a wide variety of materials. A 3-D object is fabricated based on a computer-aided design (CAD) model. The AM process can manufacture a solid three-dimensional object directly from the CAD model without additional tooling.

One example of an AM process is powder bed fusion (PBF), which uses a laser, electron beam, or other source of energy to sinter or melt powder deposited in a powder bed, thereby consolidating powder particles together in targeted areas to produce a 3-D structure having the desired geometry. Different materials or combinations of materials, such as metals, plastics, and ceramics, may be used in PBF to create the 3-D object. Other AM techniques, including those discussed further below, are also available or under current development, and each may be applicable to the present disclosure.

Another example of an AM process is called Binder Jet (BJ) process that uses a powder bed (similar to PBF) in which metallic powder is spread in layers and bonded by using an organic binder. The resulting part is a green part which requires burning off the binder and sintering to consolidate the layers into full density. The metallic powder material can have the same chemical composition and similar physical characteristics as PBF powders.

Another example of an AM process is called Directed Energy Deposition (DED). DED is an AM technology that uses a laser, electron beam, plasma, or other method of energy supply, such as those in Tungsten Inert Gas (TIG), or Metal Inert Gas (MIG) welding to melt the metallic powder, wire, or rod, thereby transforming it into a solid metal object. Unlike many AM technologies, DED is not based on a powder bed. Instead, DED uses a feed nozzle to propel the powder or mechanical feed system to deliver powder, wire, or rod into the laser beam, electron beam, plasma beam, or other energy stream. The powdered metal or the wire or rod are then fused by the respective energy beam. While supports or a freeform substrate may in some cases be used to maintain the structure being built, almost all the raw material (powder, wire, or rod) in DED is transformed into solid metal, and consequently, little waste powder is left to recycle. Using a layer by layer strategy, the print head, comprised of the energy beam or stream and the raw material feed system, can scan the substrate to deposit successive layers directly from a CAD model.

PBF, BJ, DED, and other AM processes may use various raw materials such as metallic powders, wires, or rods. The raw material may be made from various metallic materials. Metallic materials may include, for example, aluminum, or alloys of aluminum. It may be advantageous to use alloys of aluminum that have properties that improve functionality within AM processes. For example, particle shape, powder size, packing density, melting point, flowability, stiffness, porosity, surface texture, density electrostatic charge, as well as other physical and chemical properties may impact how well an aluminum alloy performs as a material for AM. Similarly, raw materials for AM processes can be in the form of wire or rod whose chemical composition and physical characteristics may impact the performance of the material. Some alloys may impact one or more of these or other traits that affect the performance of the alloy for AM.

One or more aspects of the present disclosure may be described in the context of the related technology. None of the aspects described herein are to be construed as an admission of prior art, unless explicitly stated herein.

### SUMMARY

Several aspects of the present disclosure are described herein.

A method in accordance with an aspect of the present disclosure may comprise collecting a material in a container, the material comprising oxidized aluminum powder, processing the material, which includes heating the material to melt at least a portion of the oxidized aluminum powder, and forming the processed material into at least one component.

Such a method further optionally includes other features, such as determining the at least one component based at least in part on a chemical composition of the processed material, processing the material including at least hot isostatic pressing, sintering, die casting, hot pressing plus cold drawing, hot pressing, spark plasma sintering plus extrusion, mold forging, or induction melting, performing the processing at between 80 MPa to 500 MPa, performing the processing at between 170° C. to 640° C., the material further comprising a printed support structure, processing the printed support structure prior to processing the material, processing the printed support structure comprising at least ball milling or grinding, the component being a build plate for a three-dimensional printer, the material further comprising at least one plate, processing the material further comprising binding the oxidized aluminum powder to the at least one plate, the at least one plate comprising at least one of stainless steel and an oxidation-corrosion resistant alloy, forming the processed material into at least one component comprising machining the processed material, forming the processed material into at least one component further comprising machining the container, the material further comprising impurities produced by a three-dimensional printing process, the material being a waste material from a previous three-dimensional printing operation, and the material being unusable as feed material in a three-dimensional printing operation

A method in accordance with an aspect of the present disclosure may comprise collecting waste material from a three-dimensional printing process in a container, the waste material comprising at least oxidized aluminum powder, hot isostatic pressing the waste material to form an ingot, and forming the ingot into at least one component.

Such a method further optionally includes other features, such as hot isostatic pressing the waste material comprising performing the hot isostatic pressing at between 100 MPa to 250 MPa and at between 340° C. to 620° C., the waste material further comprising a printed support structure, processing the printed support structure prior to hot isostatic pressing the waste material, processing the printed support structure comprising at least ball milling or grinding, the at least one component including a build plate, the waste material further comprising at least one plate, and hot isostatic pressing the waste material further comprising binding the oxidized aluminum powder to the at least one plate.

It will be understood that other aspects of repurposing the waste created during additive manufacturing will become readily apparent to those of ordinary skill in the art from the following detailed description, wherein it is shown and described only several embodiments by way of illustration. As will be realized by those of ordinary skill in the art, the manufactured structures and the methods for manufacturing these structures are capable of other and different embodiments, and its several details are capable of modification in various other respects, all without departing from the disclosure. Accordingly, the drawings and detailed description are to be regarded as illustrative in nature and not as restrictive.

### BRIEF DESCRIPTION OF THE DRAWINGS

Various aspects of repurposing the waste created during additive manufacturing, for example, in automotive, aerospace, and/or other engineering contexts are presented in the detailed description by way of example, and not by way of limitation, in the accompanying drawings, wherein:

FIGS. 1A-1D illustrate respective side views of a 3-D printer system in accordance with an aspect of the present disclosure.

FIG. 1E illustrates a functional block diagram of a 3-D printer system in accordance with an aspect of the present disclosure.

FIG. 2 illustrates a cross-sectional view of a material container in accordance with an aspect of the present disclosure.

FIG. 3 illustrates a material container in accordance with an aspect of the present disclosure.

FIG. 4 illustrates a cross-sectional view of a material container in accordance with an aspect of the present disclosure.

FIG. 5 illustrates a cross-sectional view of a material container in accordance with an aspect of the present disclosure.

FIG. 6 illustrates a cross sectional view of a material in accordance with an aspect of the present disclosure.

FIG. 7 shows a flow diagram illustrating an exemplary method for removal of supports from additively manufactured structures in accordance with an aspect of the present disclosure.

FIG. 8 shows a flow diagram illustrating an exemplary method for additively manufacturing a part or component in accordance with an aspect of the present disclosure.

### DETAILED DESCRIPTION

The detailed description set forth below in connection with the appended drawings is intended to provide a description of various exemplary embodiments are not intended to represent the only embodiments in which the disclosure may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the disclosure to those of ordinary skill in the art. However, the techniques and approaches of the present disclosure may be practiced without these specific details. In some instances, well-known structures and components may be shown in block diagram form, or omitted entirely, in order to avoid obscuring the various concepts presented throughout this disclosure.

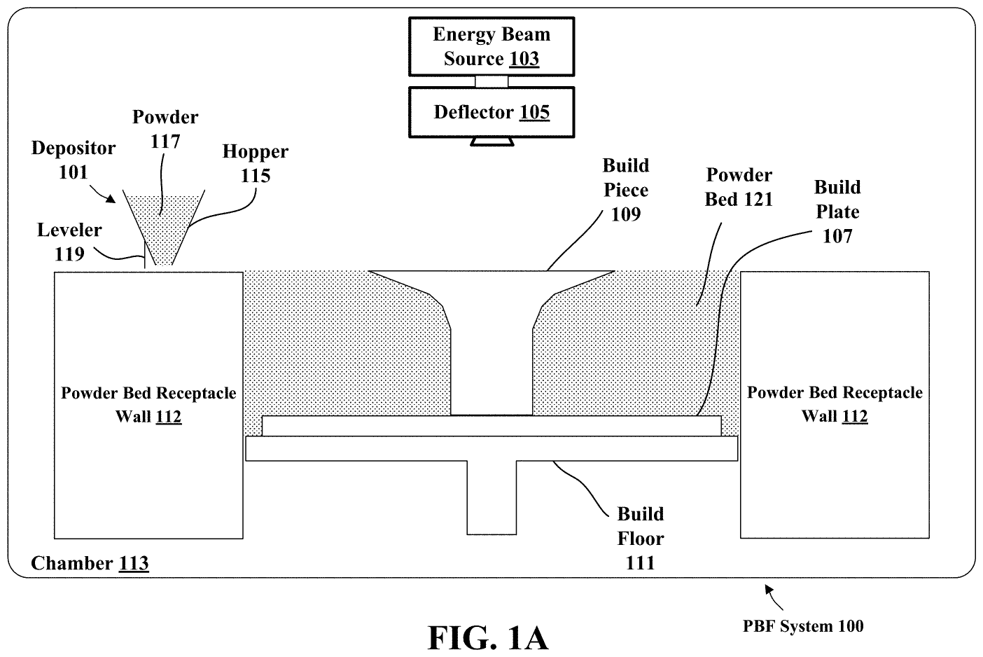

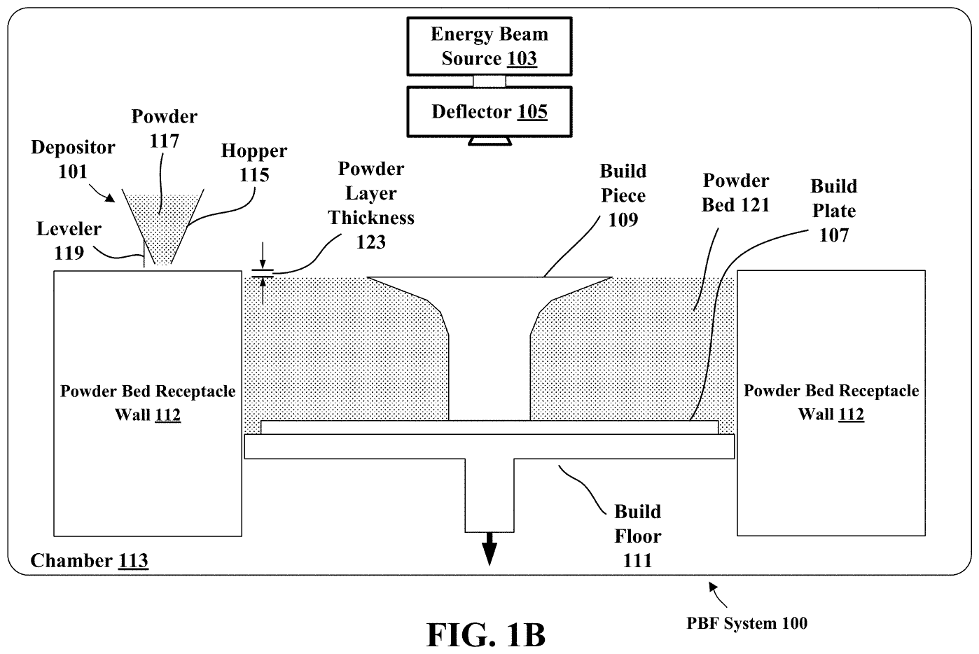

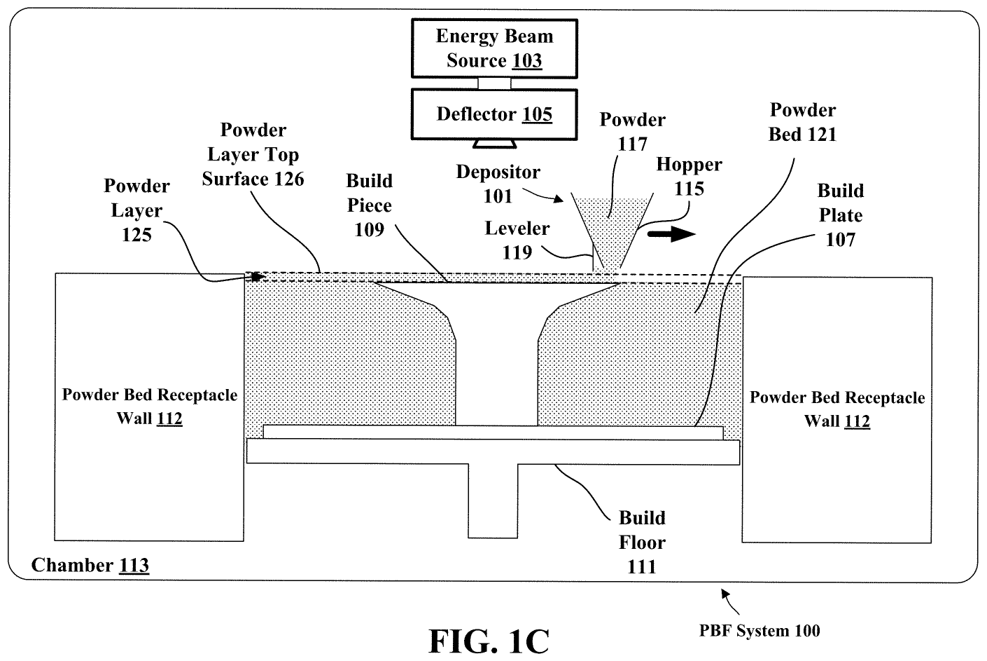

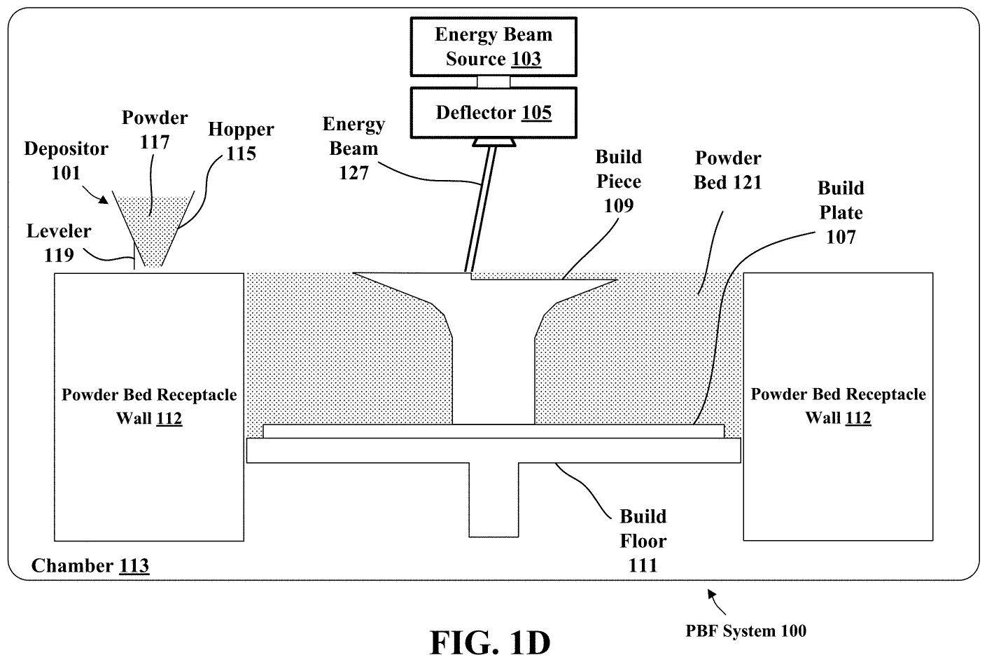

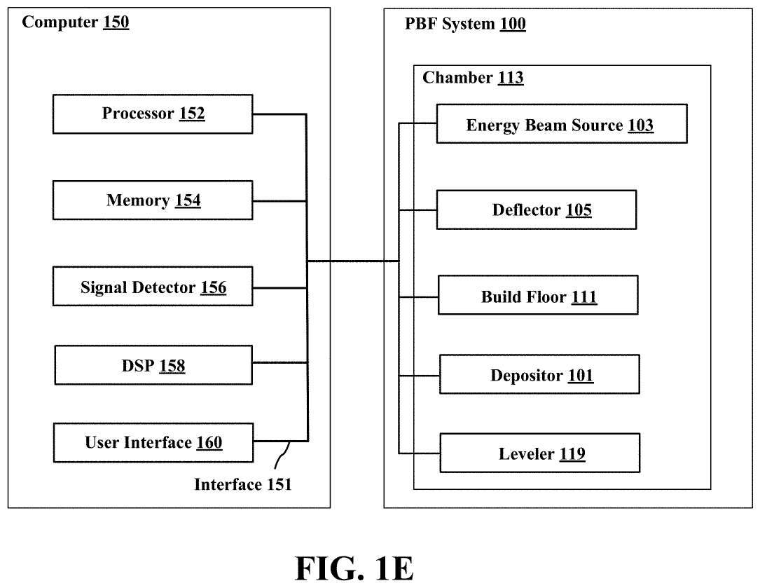

FIGS. 1A-D illustrate respective side views of an exemplary 3-D printer system.

In this example, the 3-D printer system is a powder-bed fusion (PBF) system 100. FIGS. 1A-D show PBF system 100 during different stages of operation. The particular embodiment illustrated in FIGS. 1A-D is one of many suitable examples of a PBF system employing principles of this disclosure. It should also be noted that elements of FIGS. 1A-D and the other figures in this disclosure are not necessarily drawn to scale, but may be drawn larger or smaller for the purpose of better illustration of concepts described herein.

PBF System 100 may be an electron-beam PBF system 100, a laser PBF system 100, or other type of PBF system 100. Further, other types of 3-D printing, such as Directed Energy Deposition, Selective Laser Melting, Binder Jet, etc., may be employed without departing from the scope of the present disclosure.

PBF system 100 can include a depositor 101 that can deposit each layer of metal powder, an energy beam source 103 that can generate an energy beam, a deflector 105 that can apply the energy beam to fuse the powder material, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of the present disclosure.

PBF system 100 can also include a build floor 111 positioned within a powder bed receptacle. The walls 112 of the powder bed receptacle generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 can include a hopper 115 that contains a powder 117, such as a metal powder, and a leveler 119 that can level the top of each layer of deposited powder.

AM processes may produce various support structures that need to be removed. The particular embodiments illustrated in FIGS. 1A-D are some suitable examples of a PBF system employing principles of the present disclosure. Specifically, support structures and methods to remove them described herein may be used in at least one PBF system 100 described in FIGS. 1A-D. While one or more methods described in the present disclosure may be suitable for various AM processes (e.g., using a PBF system, as shown in FIGS. 1A-D), it will be appreciated that one or more methods of the present disclosure may be suitable for other applications, as well. For example, one or more methods described herein may be used in other fields or areas of manufacture without departing from the scope of the present disclosure. Accordingly, AM processes employing the one or more methods of the present disclosure are to be regarded as illustrative, and are not intended to limit the scope of the present disclosure.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 150 layers, to form the current state of build piece 109, e.g., formed of 150 slices. The multiple layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that has a thickness substantially equal to the powder layer thickness 123 (see FIG. 1B) and exposing powder layer top surface 126. Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 150 previously-deposited layers discussed herein with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse the next slice in build piece 109. In various exemplary embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Deflector 105 can include an optical system that uses reflection and/or refraction to manipulate the laser beam to scan selected areas to be fused.

In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

FIG. 1E illustrates a functional block diagram of a 3-D printer system in accordance with an aspect of the present disclosure.

In an aspect of the present disclosure, control devices and/or elements, including computer software, may be coupled to PBF system 100 to control one or more components within PBF system 100. Such a device may be a computer 150, which may include one or more components that may assist in the control of PBF system 100. Computer 150 may communicate with a PBF system 100, and/or other AM systems, via one or more interfaces 151. The computer 150 and/or interface 151 are examples of devices that may be configured to implement the various methods described herein, that may assist in controlling PBF system 100 and/or other AM systems.

In an aspect of the present disclosure, computer 150 may comprise at least one processor 152, memory 154, signal detector 156, a digital signal processor (DSP) 158, and one or more user interfaces 160. Computer 150 may include additional components without departing from the scope of the present disclosure.

Processor 152 may assist in the control and/or operation of PBF system 100. The processor 152 may also be referred to as a central processing unit (CPU). Memory 154, which may include both read-only memory (ROM) and random access memory (RAM), may provide instructions and/or data to the processor 152. A portion of the memory 154 may also include non-volatile random access memory (NVRAM). The processor 152 typically performs logical and arithmetic operations based on program instructions stored within the memory 154. The instructions in the memory 154 may be executable (by the processor 152, for example) to implement the methods described herein.

The processor 152 may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

The processor 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

Signal detector 156 may be used to detect and quantify any level of signals received by the computer 150 for use by the processor 152 and/or other components of the computer 150. The signal detector 156 may detect such signals as energy beam source 103 power, deflector 105 position, build floor 111 height, amount of powder 117 remaining in depositor 101, leveler 119 position, and other signals. DSP 158 may be used in processing signals received by the computer 150. The DSP 158 may be configured to generate instructions and/or packets of instructions for transmission to PBF system 100.

The user interface 160 may comprise a keypad, a pointing device, and/or a display.

The user interface 160 may include any element or component that conveys information to a user of the computer 150 and/or receives input from the user.

The various components of the computer 150 may be coupled together by interface 151, which may include, e.g., a bus system. The interface 151 may include a data bus, for example, as well as a power bus, a control signal bus, and a status signal bus in addition to the data bus. Components of the computer 150 may be coupled together or accept or provide inputs to each other using some other mechanism.

Although a number of separate components are illustrated in FIG. 1E, one or more of the components may be combined or commonly implemented. For example, the processor 152 may be used to implement not only the functionality described herein with respect to the processor 152, but also to implement the functionality described herein with respect to the signal detector 156, the DSP 158, and/or the user interface 160. Further, each of the components illustrated in FIG. 1E may be implemented using a plurality of separate elements.

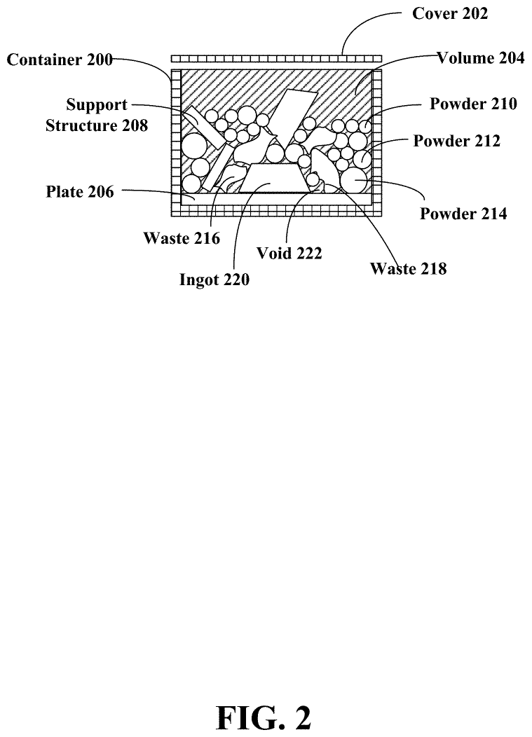

FIG. 2 illustrates a cross-sectional view of a material container in accordance with an aspect of the present disclosure.

As described with respect to FIGS. 1A-1D, some powder 117 that is deposited in powder bed 121 may not be incorporated in build piece 109, may be formed into support structures within or as part of build piece 109 and removed, or may otherwise be considered “waste” materials from the additive manufacturing process. Such powders, support structures, build plates 107, etc. may be considered as unusable or undesirable for use in build piece 109.

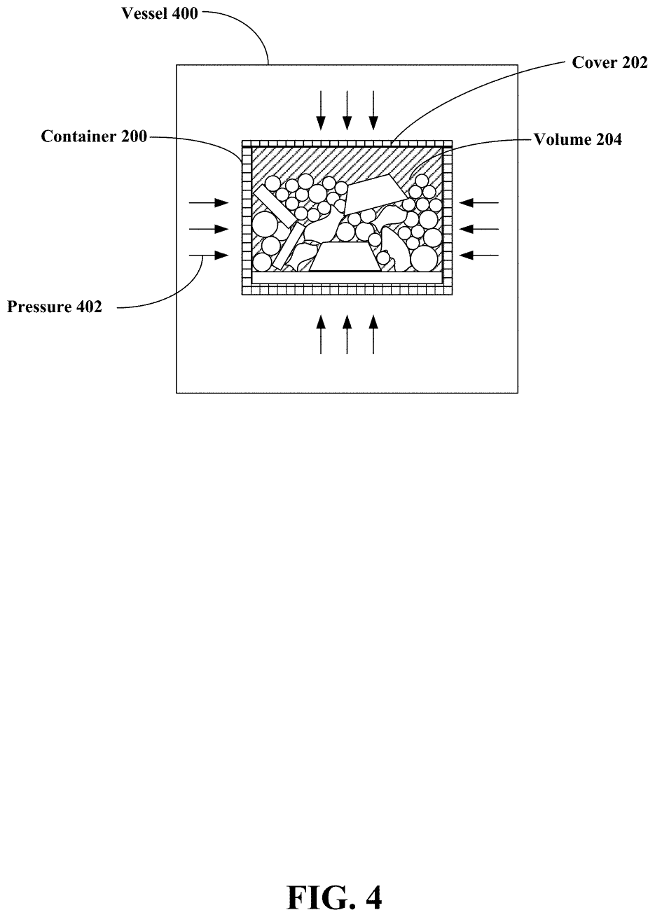

As shown in FIG. 2, a material container 200, which may have a cover 202, may define a volume 204 within material container 200 when cover 202 is coupled to material container 200. Within volume 204, various particles of powder and other materials may be collected and placed within container 200. Volume 204 is shown as a shaded area in the two-dimensional figure of FIG. 2 to indicate that some of volume 204 may not be completely filled by the various materials collected in container 200. Material container 200 may be made of aluminum, aluminum alloy, or other metals as desired. The melting point of material container 200 may be higher than that of pure aluminum. The size of material container 200 may vary depending on a number of factors, e.g., the amount of material to be placed in material container 200, the size of any vessels (described with respect to FIG. 4) available, the size of any final product to be made from the material in material container 200, or other factors.

In an aspect of the present disclosure, the material collected in material container 200 may include one or more of plate 206, support structure 208, powder 210, powder 212, powder 214, waste 216, waste 218, and ingot 220. Although shown as being of similar size in FIG. 2, plate 206, support structure 208, powder 210, powder 212, powder 214, waste 216, waste 218, and ingot 220 may be of any size relative to the other material and take any shape without departing from the scope of the present disclosure. Material container 200 may Not include all of the materials listed, i.e., plate 206, support structure 208, powder 210, powder 212, powder 214, waste 216, waste 218, and ingot 220. One or more of the materials listed may be absent from material container without departing from the scope of the present disclosure. One or more of the materials listed may include oxidized aluminum, SOOT without departing from the scope of the present disclosure,

Plate 206 may be a build plate 107, or a plurality of build plates 107, and may be placed on the bottom of container 200, in the middle of material container 200, on the top and bottom of material container 200, or elsewhere within material container 200. Plate 206 may be aluminum, oxidized aluminum, an aluminum alloy, stainless steel, an oxidation-corrosion resistant alloy, or other materials.

Support structure 208 may be a support structure that has been removed or otherwise broken away from a build piece 109. Support structure 208 may be aluminum, oxidized aluminum, an aluminum alloy, or other materials, and may be a different material than plate 206. Support structure 208 may have been processed prior to being placed into material container 200. Such prior processing may include ball milling, grinding, or other processes.

Powder 210, powder 212, and powder 214 may be one or more powders that were previously used in additive manufacturing of one or more build pieces 109, and may be the same powder or different powders having different chemical components. Powder 210, powder 212, and powder 214 may be aluminum, oxidized aluminum, an aluminum alloy, or other materials, and may be a different material than plate 206 and/or support structure 208. Powder 210, powder 212, and powder 214 may be collected from overflow compartments in PBF system 100 or may be left over from use in PBF system 100. Powder 210, powder 212, and/or powder 214 may also contain impurities produced by PBF system 100 during operation, e.g., soot, evaporation, sintering, or powder 117 melting byproducts, and/or other impurities, without departing from the scope of the present disclosure.

Waste 216 and waste 218, may be one or more pieces of waste produced during additive manufacturing of one or more build pieces 109, or other metallic waste. Waste 216 and waste 218 may be, for example, milling shavings, build pieces 109 that were out of tolerance, broken pieces of old build pieces 109, or other waste components of the manufacturing process. Waste 216 and waste 218 may be aluminum, oxidized aluminum, an aluminum alloy, or other materials, and may be a different material than plate 206, support structure 208, powder 210, powder 212, and/or powder 214.

Ingot 220 may be an older build piece 109, or other solid piece of material that may be placed into container 200. Ingot 220 may be aluminum, oxidized aluminum, an aluminum alloy, or other materials, and may be a different material than plate 206, support structure 208, powder 210, powder 212, powder 214, waste 216 and/or waste 218.

In an aspect of the present disclosure, materials placed in material container 200 may be materials from a previous three-dimensional printing operation, e.g., printing of a build piece 109. In an aspect of the present disclosure, materials placed in material container 200 may be unusable as feed material, i.e., powder 117, in one or more PBF systems 100.

The material in material container 200 may be aluminum, aluminum alloys, steel, iron, or other materials. In an aspect of the present disclosure, aluminum alloys with having some amounts of magnesium may be beneficial for reducing Al₂O₃ (aluminum oxide) layers upon formation of a larger piece of material as described herein.

Void(s) 222 may be present in between the various materials placed in material container 200. Void 222 may be a portion of volume 204 that is not taken up by the various materials, may be in between the various materials, or may be within one or more of the materials themselves without departing from the scope of the present disclosure.

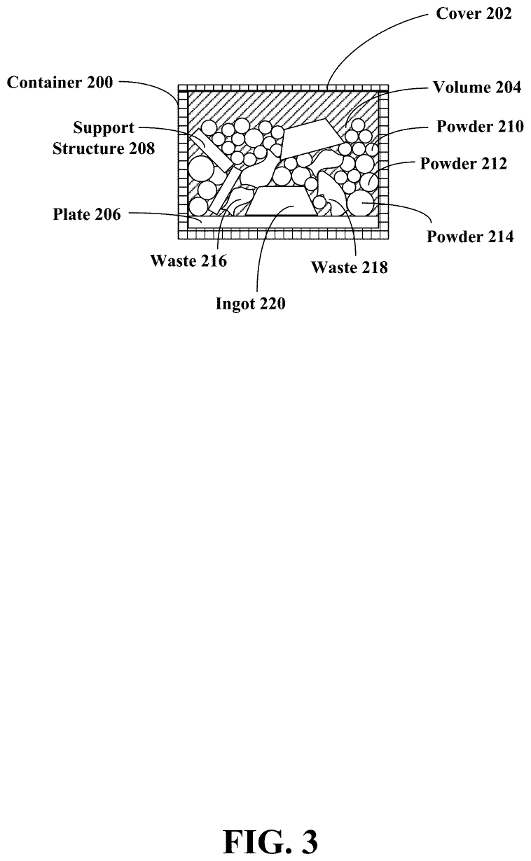

FIG. 3 illustrates a cross-sectional view of a material container in accordance with an aspect of the present disclosure.

As shown in FIG. 3, material container 200 may have cover 202 placed on container 200 to enclose volume 204 with plate 206, support structure 208, powder 210, powder 212, powder 214, waste 216, waste 218, and ingot 220 residing inside volume 204 of material container 200. Again, volume 204 is shown as not being filled with the material placed inside of material container 200.

FIG. 4 illustrates a cross-sectional view of a material container in accordance with an aspect of the present disclosure.

FIG. 4 illustrates material container 200 placed inside of vessel 400. Vessel 400 may be an oven, furnace, pressure chamber, or other device that exposes material container to heat and/or pressure.

In an aspect of the present disclosure, vessel 400 may apply one or more processes to material container 200 and material placed within material container 200. Such processes may include hot isostatic pressing, sintering, die casting, hot pressing combined with cold drawing, hot pressing, spark plasma sintering plus extrusion, mold forging, and/or induction melting.

In an aspect of the present disclosure, vessel 400 may be a device capable of Hot Isostatic Pressing (HIP) the material collected within material container 200. Hot Isostatic Pressing (HIP) of material is the simultaneous application of high temperature, e.g., temperatures between 150° C. and 800° C. and high pressure 402, e.g., pressures between 50 megapascals (1MPa) and 600 MPa to metals and/or other materials. The application of temperature and pressure 402 to the material in material container 200 may improve the mechanical properties of the material, and may perform sintering or other attachment processes on the various materials inside material container 200.

In an aspect of the present disclosure, vessel 400 may heat material container 200, and the material contained within material container 200, to such a temperature that at least a portion of powder 210, powder 212, powder 214, which may include oxidized aluminum powder, is melted. In an aspect of the present disclosure, at least a portion of powder 210, powder 212, powder 214, which may include oxidized aluminum powder, may be bound to other portions of the material in material container. In such an aspect, the powder may be bound to plate 206.

The temperature ranges applied may vary based on the materials within material container 200, the material of the material container 200 itself, or other factors. For example, the temperature ranges may be between 160° C. and 700° C., 170° C. and 640° C., 140° C. and 620° C., 340° C. to 620° C., or other ranges without departing from the scope of the present disclosure. The temperature ranges may be controlled or have tolerances of +/−15° C., +/−20° C., +/−5° C., +/−25° C., or other ranges without departing from the scope of the present disclosure.

The pressure ranges applied may vary based on the materials within material container 200, the material of the material container 200 itself, or other factors. For example, the pressure ranges may be between 50 MPa and 1000 MPa, 80 MPa and 500 MPa, 150 MPa to 800 MPa, 100 MPa to 250 MPa, or other ranges without departing from the scope of the present disclosure. The pressure ranges may be controlled or have tolerances of +/−15 MPa, +/−20 MPa, +/−5 MPa, +/−25 MPa, or other ranges without departing from the scope of the present disclosure.

Vessel 400, when embodied as an HIP vessel, exposes material container 200 and the material therein to elevated temperatures and pressures for a given amount of time, e.g., a couple of hours. The material within material container 200 may be heated in an inert gas, which may be argon, nitrogen, or other inert gas, which may also be used to apply substantially uniform pressure 402 to the material in material container 200 from all directions. This substantially uniform pressure 402 from all directions is referred to as “isostatic” pressure. The application of heat and pressure 402 may cause the material in material container 200 to become malleable, i.e., less rigid, which allows voids in volume 204 lying between the various materials to be reduced. In other words, the pressure 402 applied on all sides to heated, “plasticized” materials collapses the voids in volume 204. The surfaces of each piece of material in volume 204 bond together, and with application of sufficient pressure 402 and heat, the voids and/or defects in the final product are effectively eliminated.

HIP is often used to improve the mechanical properties of metals, such as titanium, steel, and aluminum, and other materials, e.g., ceramic particles, such as oxides, on the surface of metals . Voids within volume 204 can be reduced or eliminated, and encapsulated powders, e.g., powder 210, powder 212, powder 214, etc., can be consolidated to create denser materials. HIP can also be used to bond dissimilar materials within material container 200 together.

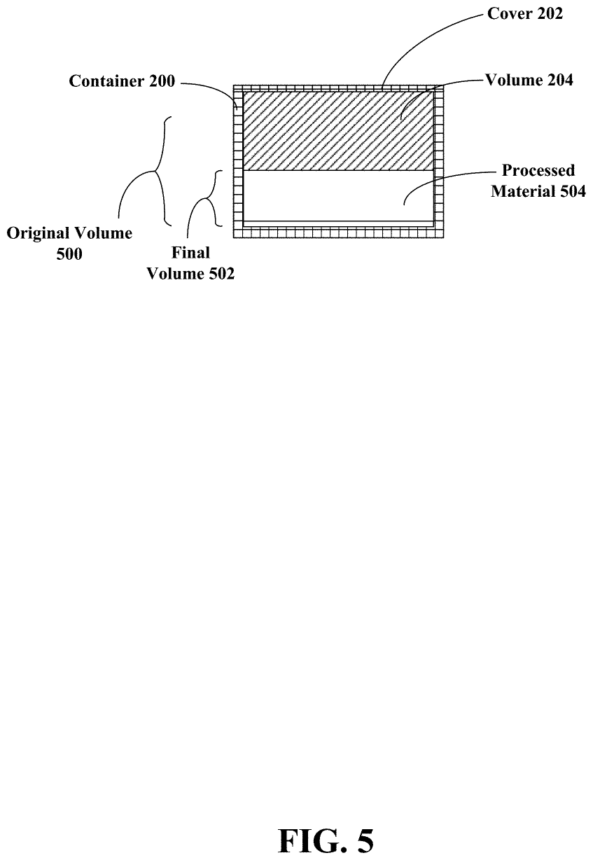

FIG. 5 illustrates a cross-sectional view of a material container in accordance with an aspect of the present disclosure.

After subjecting material container 200 to heat and/or pressure as shown in FIG. 4, the original volume 500 of material inside material container 200 may have been reduced to final volume 502. The differential in volume of the material between original volume 500 and final volume 502 may be shown as exaggerated in FIG. 5 to illustrate the compaction of the material in material container 200. The void(s) 220 in the material, however, may be reduced and/or eliminated after the application of heat and/or pressure as described with respect to FIG. 4. The material remaining in material container 200 may be referred to as a “consolidated” material after removal of material container 200 from vessel 400. The consolidation may be a sintering of material, or other formation of material inside material container 200.

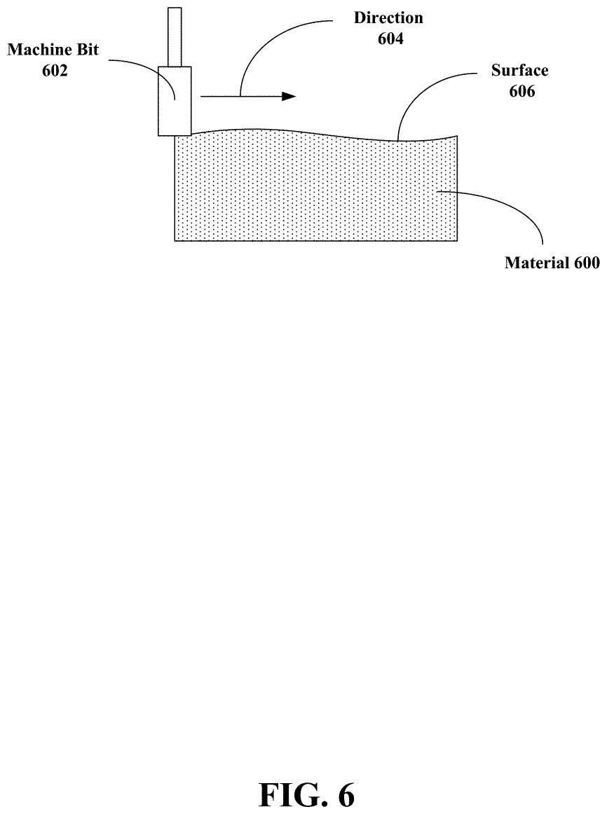

FIG. 6 illustrates a cross sectional view of a material in accordance with an aspect of the present disclosure.

Material 600, which may include the material placed in material container 200 and reduced to final volume 502 as described above, may then be machined by machine bit 602 in one or more directions 604. For example, and not by way of limitation, machine bit 602 may be a milling bit that flattens surface 606 of material 600. Machine bit 602 may also be a saw blade that cuts material 600 into one or more shapes, a drill bit that drills holes in material 600, or may be another machining tool that performs other machining operations on material 600 as desired. Material 600 may be considered as an ingot after being processed in vessel 400 without departing from the scope of the present disclosure.

In an aspect of the present disclosure, material 600 may be cut, machined, milled, or otherwise formed into a build plate 107 for use in PBF system 100 on a subsequent build piece 109, or as part of another additive manufacturing component.

In an aspect of the present disclosure, material 600 may be formed by placing one or more plates of material in material container 200, e.g., a first plate 206 may be placed on the bottom of material container 200 and a second plate 206 may be placed on top of the material in container 200 prior to placing material container 200 into vessel 400. This may produce a hybrid material 600, with various materials sandwiched between the first plate 206 and the second plate 206. In an aspect of the present disclosure, the plates 206, as well as the other materials in material 600, may include different materials. For example, and not by way of limitation, the first plate 206 may be stainless steel, material on top of the first plate 206 may be an oxidation-corrosion resistant alloy powder 214 (e.g., Inconel®), and the second or top plate 206 may be an oxidation-corrosion resistant aluminum alloy.

In an aspect of the present disclosure, material container 200 may be consolidated as part of material 600. Material container 200 may include steel, oxidation-corrosion resistant alloys, and/or material with similar Coefficient of Thermal Expansion (CTE) as the material(s) placed within material container 200. After the consolidation of material 600, and, in this aspect, of material container 200 with the materials placed within material container 200, is complete, i.e., the consolidation described with respect to FIGS. 4 and 5, the material 600, which includes the consolidated material container 200, may be processed as described with respect to FIG. 6.

In an aspect of the present disclosure, build plates 107 may be recycled and/or otherwise re-used within PBF system 100. Such reuse of the build plate 107 may reduce the overall cost of additive manufacturing. For example, and not by way of limitation, a build plate 107 with an initial 5″ thickness may be machined after use to remove build piece 109, resurfacing of build plate 107, etc. As build plate 107 reaches a reduced thickness that may not properly support a build piece 109, a refurbished or “new” build plate 107 with an increased thickness can be made through the consolidation of build plate 107 with additional material through the consolidation process described herein.

In an aspect of the present disclosure, the component or components produced from material 600 through machining or other processing by one or more machine bits 602 may be selected based on the material 600, the chemical composition of material 600 (which may be determined by the material placed in material container 200 and/or material container 200), the desired use of the component, and/or other factors.

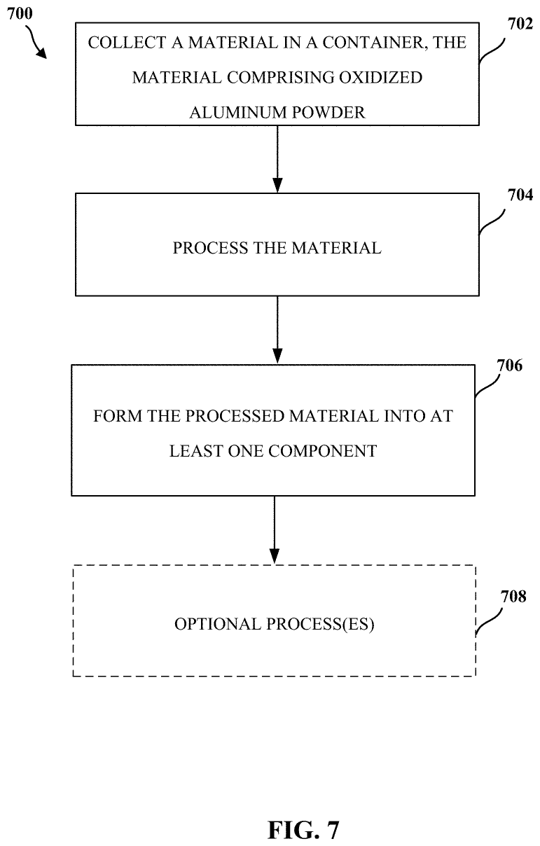

FIG. 7 shows a flow diagram illustrating an exemplary method for removal of supports from additively manufactured structures in accordance with an aspect of the present disclosure.

FIG. 7 shows a flow diagram illustrating an exemplary method 700 for additively manufacturing a part in accordance with an aspect of the present disclosure. The objects that perform, at least in part, the exemplary functions of FIG. 7 may include, for example, computer 150 and one or more components therein, a three-dimensional printer, such as illustrated in FIGS. 1A-E, and other objects that may be used for forming the above-referenced materials.

It should be understood that the steps identified in FIG. 7 are exemplary in nature, and a different order or sequence of steps, and additional or alternative steps, may be undertaken as contemplated in this disclosure to arrive at a similar result.

At 702, a material is collected in a container, the material comprising oxidized aluminum powder.

An optional addition to 702 may be the material further comprising impurities produced by a three-dimensional printing process. Another optional addition to 702 is the material being a waste material from a previous three-dimensional printing operation is agitating the 3-D printed part while the demolition object is within the hollow portion of the 3-D printed part. Another optional addition to 702 is the material being unusable as feed material in a three-dimensional printing operation. Another optional addition to 702 is the material being at least one plate.

Other optional additions to 702 may include the material comprising a printed support structure, processing the printed support structure prior to processing the material, and processing the printed support structure comprising at least ball milling or grinding.

At 704, the material is processed. The processing includes heating the material to melt at least a portion of the oxidized aluminum powder.

An optional addition to 704 may be the processing including at least hot isostatic pressing, sintering, die casting, hot pressing plus cold drawing, hot pressing, spark plasma sintering plus extrusion, mold forging, or induction melting. Another optional addition to 704 is the processing being performed at between 50 MPa and 1000 MPa, 80 MPa and 500 MPa, 150 MPa to 800 MPa, 100 MPa to 250 MPa or other ranges, at between +/−15 MPa, +/−20 MPa, +/−5 MPa, +/−25 MPa, or other tolerances. Another optional addition to 704 is the processing being performed at between 160° C. and 700° C., 170° C. and 640° C., 140° C. and 620° C., 340° C. to 620° C., or other ranges, at between +/−15° C., +/−20° C., +/−5° C., +/−25° C., or other tolerances.

An optional addition to 704 may be binding the oxidized aluminum powder to at least one plate, the at least one plate comprising at least one of stainless steel and an oxidation-corrosion resistant alloy

At 706, the processed material is formed into at least one component.

An optional addition to 706 may be the component being a build plate for a three-dimensional printer. An optional addition to 706 may be machining the processed material. An optional addition to 706 may be machining the container.

At 708, optional additional processes may be performed. Such optional processes may include determining the at least one component based at least in part on a chemical composition of the processed material.

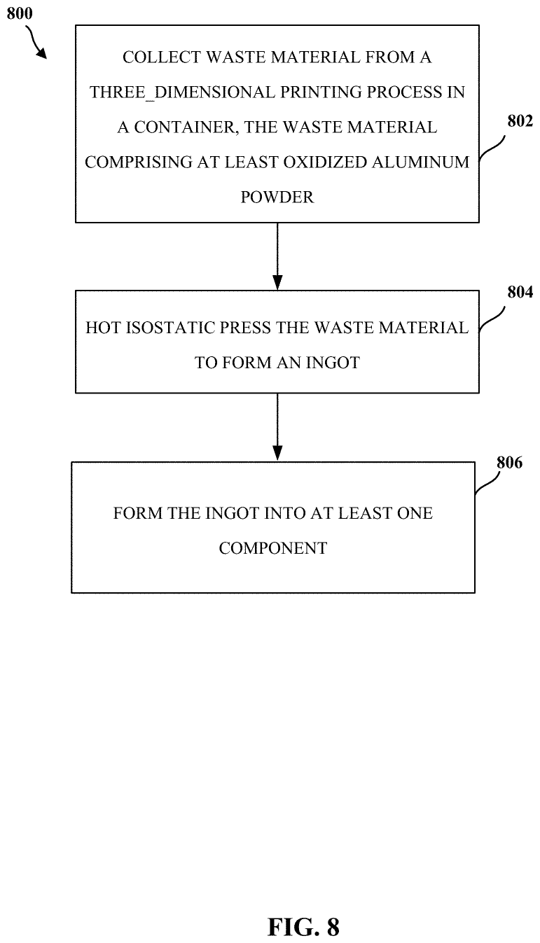

FIG. 8 shows a flow diagram illustrating an exemplary method for removal of supports from additively manufactured structures in accordance with an aspect of the present disclosure.

FIG. 8 shows a flow diagram illustrating an exemplary method 800 for additively manufacturing a part in accordance with an aspect of the present disclosure. The objects that perform, at least in part, the exemplary functions of FIG. 8 may include, for example, computer 150 and one or more components therein, a three-dimensional printer, such as illustrated in FIGS. 1A-E, and other objects that may be used for forming the above-referenced materials.

At 802, waste material is collected from a three-dimensional printing process in a container, the waste material comprising at least oxidized aluminum powder.

An optional addition to 802 may be the waste material including a printed support structure. An optional addition to 802 may be processing the printed support structure prior to 804. An optional addition to 802 may be the processing of the printed support structure comprising at least ball milling or grinding. An optional addition to 802 may be the waste material comprising at least one plate.

At 804, the waste material is hot isostatic pressed to form an ingot.

An optional addition to 804 may be performing the hot isostatic pressing at between Another optional addition to 804 is the processing being performed at between 50 MPa and 1000 MPa, 80 MPa and 500 MPa, 150 MPa to 800 MPa, 100 MPa to 250 MPa or other ranges, at between +/−15 MPa, +/−20 MPa, +/−5 MPa, +/−25 MPa, or other tolerances. Another optional addition to 804 is the processing being performed at between 160° C. and 700° C., 170° C. and 640° C., 140° C. and 620° C., or other ranges, at between +/−15° C., +/−20° C., +/−5° C., +/−25° C., or other tolerances.

Another optional addition to 804 may be binding the oxidized aluminum powder to at least one plate.

At 806, the ingot is formed into at least one component.

An optional addition to 806 may be the at least one component including a build plate.

The previous description is provided to enable any person ordinarily skilled in the art to practice the various aspects described herein. Various modifications to these exemplary embodiments presented throughout this disclosure will be readily apparent to those of ordinary skill in the art, and the concepts disclosed herein may be applied to aluminum alloys. Thus, the claims are not intended to be limited to the exemplary embodiments presented throughout the disclosure but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A method comprising:
collecting a material in a container, the material comprising oxidized aluminum powder;
processing the material, wherein the processing includes heating the material to melt at least a portion of the oxidized aluminum powder; and
forming the processed material into at least one component.

2. The method of claim 1, further comprising determining the at least one component based at least in part on a chemical composition of the processed material.

3. The method of claim 1, wherein processing the material includes at least hot isostatic pressing, sintering, die casting, hot pressing plus cold drawing, hot pressing, spark plasma sintering plus extrusion, mold forging, or induction melting.

4. The method of claim 3, wherein processing the material comprises performing the processing at between 80 MPa to 500 MPa.

5. The method of claim 3, wherein processing the material comprises performing the processing at between 170° C. to 640° C.

6. The method of claim 1, wherein the material further comprises a printed support structure.

7. The method of claim 6, further comprising processing the printed support structure prior to processing the material.

8. The method of claim 7, wherein processing the printed support structure comprises at least ball milling or grinding.

9. The method of claim 1, wherein the component is a build plate for a three-dimensional printer.

10. The method of claim 1, wherein the material further comprises at least one plate.

11. The method of claim 10, wherein processing the material further comprises binding the oxidized aluminum powder to the at least one plate.

12. The method of claim 11, wherein the at least one plate comprises at least one of stainless steel and an oxidation-corrosion resistant alloy.

13. The method of claim 1, wherein forming the processed material into at least one component comprises machining the processed material.

14. The method of claim 13, wherein forming the processed material into at least one component further comprises machining the container.

15. The method of claim 1, wherein the material further comprises impurities produced by a three-dimensional printing process.

16. The method of claim 15, wherein the material is a waste material from a previous three-dimensional printing operation.

17. The method of claim 1, wherein the material is unusable as feed material in a three-dimensional printing operation.

18. A method comprising:
collecting waste material from a three-dimensional printing process in a container, the waste material comprising at least oxidized aluminum powder;
hot isostatic pressing the waste material to form an ingot; and
forming the ingot into at least one component.

19. The method of claim 18, wherein hot isostatic pressing the waste material comprises performing the hot isostatic pressing at between 100 MPa to 250 MPa and at between 340° C. to 620° C.

20. The method of claim 19, wherein the waste material further comprises a printed support structure.

21. The method of claim 20, further comprising processing the printed support structure prior to hot isostatic pressing the waste material.

22. The method of claim 21, wherein processing the printed support structure comprises at least ball milling or grinding.

23. The method of claim 18, wherein the at least one component includes a build plate.

24. The method of claim 18, wherein the waste material further comprises at least one plate.

25. The method of claim 24, wherein hot isostatic pressing the waste material further comprises binding the oxidized aluminum powder to the at least one plate.
